(19) United States
(12) Patent Application Publication
(10) Pub. No.: US 2002/0142727 A1
(43) Pub. Date: Oct. 3, 2002

(54) Warning and telecommunicating system

(76) Inventor: Te Hsin Hsu, Chong Ho City (TW)

Correspondence Address: Te Hsin HSU, P.O. Box 10-69, Chong Ho, Taipei, 235, TW

(21) Appl. No.: 09/819,563

(22) Filed: Mar. 27, 2001

(51) Int. Cl. H04Q 7/00

(52) U.S. Cl. 455/66; 455/345; 340/539

(57) ABSTRACT

A warning and telecommunicating system includes one or more telecommunicating devices coupled to a processing unit, and having one or more phones, such as the portable phones for sending out a warning signal to the users' home or to the users' friends, or to the customer service centers, automatically when a car accident happened, or when required. The customer service centers may watch the vehicles when receiving the warning signals, for anti-theft purposes, or for asking for helps. The users may send out a warning signal to ask for help by a quick dialing device.

### BACKGROUND OF THE INVENTION

1. Field of the Invention

The present invention relates to a telecommunicating system, and more particularly to a telecommunicating system which may generate and transmit a warning signal out to ask for help.

2. Description of the Prior Art

Typical telecommunicating systems, particularly the portable phones or the mobile phones widely used today, may be used for telecommunicating purposes only. The telecommunicating system may not be used to generate and to transmit a warning signal or the like out to ask for help.

The present invention has arisen to mitigate and/or obviate the afore-described disadvantages of the conventional telecommunicating systems.

### SUMMARY OF THE INVENTION

The primary objective of the present invention is to provide a warning and telecommunicating system which may generate and transmit a warning signal out to ask for help.

In accordance with one aspect of the invention, there is provided a warning and telecommunicating system comprising a processing unit, a first telecommunicating device coupled to the processing unit, and including an interface, a computer, and at least one phone member, a speaker for picking up an incoming phone, a microphone for speaking an out going phone, at least one handset coupled to the processing unit, a keypad for data entering purposes, and an anti-theft apparatus coupled to the processing unit. The keypad and/or the phone member and/or the handsets or the like may be used to send out a warning signal to the users'home or to the users' friends, or to the customer service centers, etc., automatically when a car accident happened, or when required. The customer service centers may monitor or watch for the movement or the status of the vehicles when receiving the warning signals from the vehicles.

The anti-theft apparatus includes at least one anti-theft device, an air bag actuating device, and a safety button.

A displayer may further be provided in a rear view mirror of a vehicle for displaying the telephones dialed or of the incoming phones.

Another telecommunicating device may further be provided and coupled to the processing unit, and includes a dialing button and a dialing screen. The phone member is a preferably a portable phone or a mobile phone. The users may also send out a warning signal to ask for help by a quick dialing device when required.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a schematic view of a warning and telecommunicating system in accordance with the present invention; and

FIG. 2 is a block diagram showing the elements of the warning and telecommunicating system.

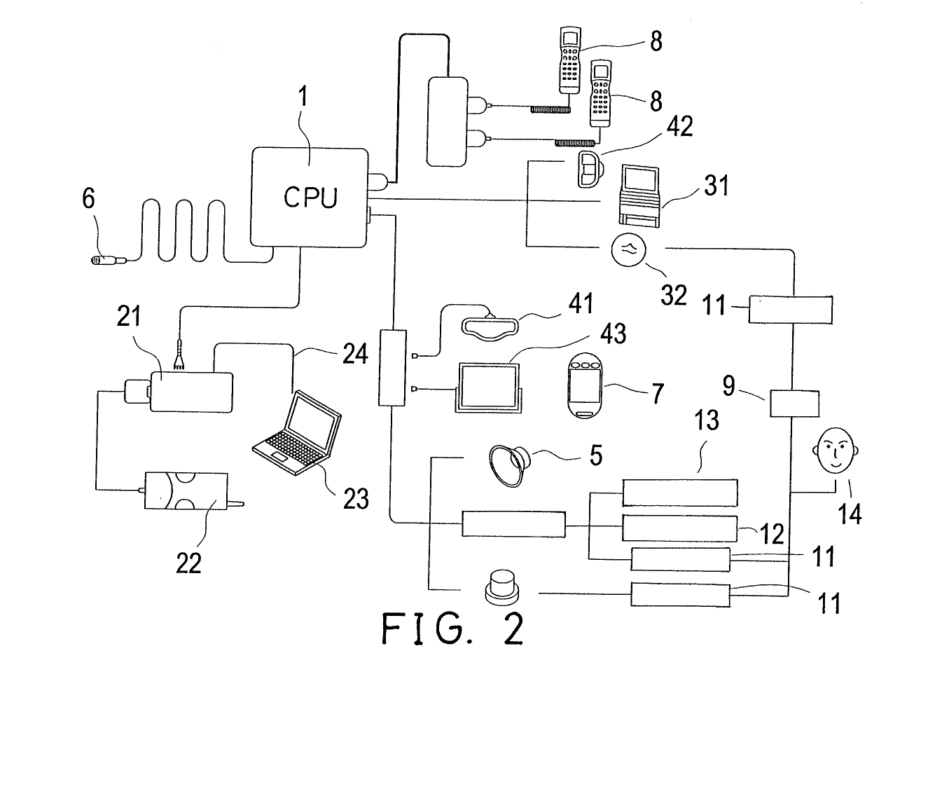

### DETAILED DESCRIPTION OF THE PREFERRED EMBODIMENT

Referring to the drawings, a warning and telecommunicating system in accordance with the present invention comprises a control device 1, such as a processing unit 1 for coupling the elements of the warning and telecommunicating system together and for actuating or operating the elements and for memorizing or processing purposes. A telecommunicating device 2 includes a computer interface 21 coupled to the processing unit 1, a personal computer (PC) or a notebook computer 23 or the like and a portable phone or a mobile phone 22 also coupled to the processing unit 1, with such as the cables 24. The interface 21 may include a build-in modem or a build-in facsimile device for transmission or facsimile purposes. The portable phone or the mobile phone 22 may include various kinds of systems or modules that may be switched or changed from each other.

A speaker 5 may be provided and disposed in the front portion of the vehicle, for allowing the drivers or the passengers to hear or to pick up the phone without carrying the handset or the like. One or more handsets S may be provided and disposed in either the front portion or the rear portion of the vehicle, for allowing the drivers or the passengers to pick up the phone. The speaker 5 may be switched off, for example, when the handsets 8 are used. One or more speakers 6 may further be provided and disposed in either the front portion or the rear portion of the vehicle, for allowing the drivers or the passengers to speak the phone without the handsets 8.

A keypad 7 may be used for dialing the phone, or for entering data into the PC 23, or for controlling the elements of the warning and telecommunicating system. A telecommunicating device 4 may further include a displayer 41 provided in the vehicle, such as provided in the rear view mirror of the vehicle, for displaying the data entering into the PC 23, or for displaying the date or the telephone numbers dialed by the users with the keypad 7, for example. A quick dialing button 42 may further be provided in the vehicle, such as attached to the steering wheel of the vehicle for quickly or rapidly dialing the required or the mostly used telephone numbers, for example. A touch-type dialing screen 43 may further be provided in the vehicle and coupled to the processing unit 1 for dialing the phone, or for entering data into the PC 23. A further control button 10 may be provided in the vehicle for selecting the required services, such as the telecommunicating phonic services, time telling services, fueling stations or parking lots searching services, mobile secretary services, etc.

An anti-theft apparatus 3 may further be provided and coupled to the processing unit 1, and may be used to receive the messages or the signals from the satellites, or from a globe position system (GPS), for monitoring or observing or watching the movement or the status of the vehicles, and for sending out a warning signal to ask for help when a car accident occurred or when the vehicle has been stolen. The control button 10 may be used to send out a signal to the satellite, for example, in order to locate the vehicle. The anti-theft apparatus 3 includes a main body, such as a processing device 31 for receiving from or for transmitting the messages or the signals to the satellites, and includes one or more anti-theft devices 33, and includes an air bag actuating or operating device 32, and a safety button 34 or the like for asking for help.

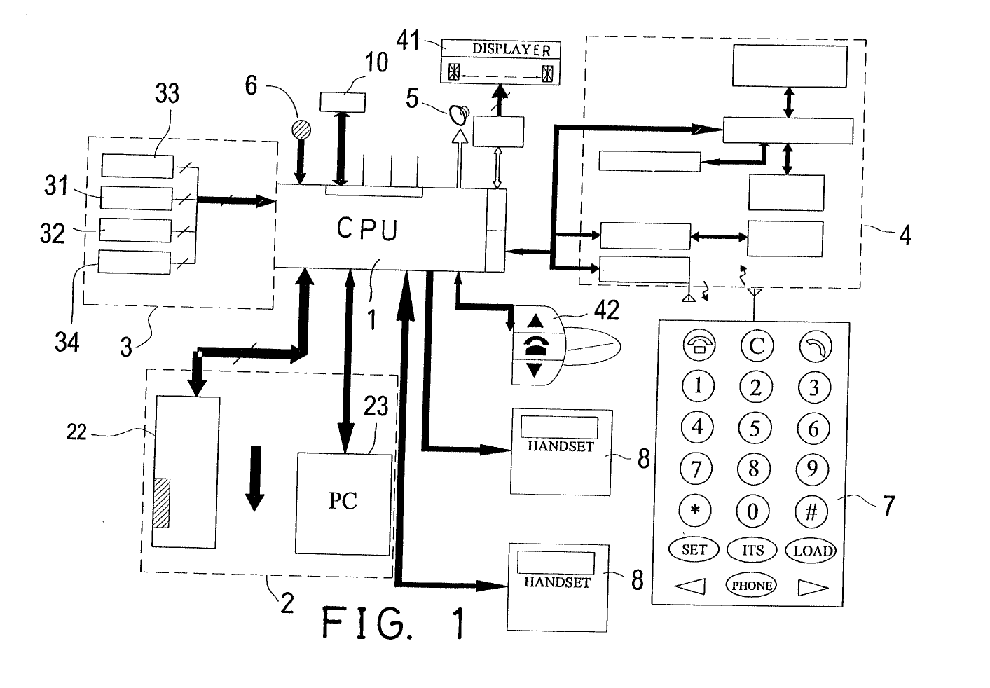

For example, when either of the anti-theft devices 33 has been actuated or operated, either the portable phone or the mobile phone 22, or the keypad 7, or the safety button 34, or the quickly dialing button 42, or the dialing screen 43 may be used to send out (11) a signal to the customer service center 9 (FIG. 1) which may monitor or watch the movement or the status of the vehicles and which may timely send out a signal or the massage to the users or the drivers of the vehicles. The portable phone or the mobile phone 22, or the like may also send out a warning signal to the handset of the users 12, and/or may send out a warning signal to the handset or the phones of the users' home 13. The keypad 7, or the safety button 34, or the quickly dialing button 42, or the dialing screen 43 may also be used to send out the signals to the required or to the predetermined positions.

When a car accident is occurred, or when the air bag is actuated or operated, the driver 14 or the passenger may depress or actuate the safety button 34 in order to send out a warning signal or to ask for help. The portable phones or the mobile phones 8 and/or the keypad 7, or the safety button 34, or the quickly dialing button 42, or the dialing screen 43 may also be used to automatically send out the signals to the required or to the predetermined positions.

It is preferable that the portable phones or the mobile phones 8 and/or the keypad 7, or the safety button 34, or the quickly dialing button 42, or the dialing screen 43 may automatically send out the signals to the required or to the predetermined positions, such as the customer service centers, the users' home phones, the users' portable phones, or even to the users' friends' phones, for asking help from the other people, when a car accident or when the other unpredictable conditions happened. The customer services centers may monitor or watch for the vehicles via the GPS system, or the like.

Accordingly, the warning and telecommunicating system in accordance with the present invention may be used to generate and transmit a warning signal out to ask for help when an accident is occurred, for example.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning and telecommunicating system comprising:
a processing unit,
a first telecommunicating device coupled to said processing unit, and including an interface, a computer, and at least one phone member,
a speaker for picking up an incoming phone,
a microphone for speaking an out going phone,
at least one handset coupled to said processing unit,
a keypad for data entering purposes, and
an anti-theft apparatus coupled to said processing unit.

2. The warning and telecommunicating system according to claim 1, wherein said anti-theft apparatus includes at least one anti-theft device, an air bag actuating device, and a safety button.

3. The warning and telecommunicating system according to claim 1 further comprising a displayer provided in a rear view mirror of a vehicle.

4. The warning and telecommunicating system according to claim 1 further comprising a second telecommunicating device coupled to said processing unit, and including a dialing button and a dialing screen.

5. The warning and telecommunicating system according to claim 1, wherein said at least one phone member is a portable phone.

6. A warning and telecommunicating system for a vehicle, said warning and telecommunicating system comprising:
a processing unit for disposing in the vehicle,
a first telecommunicating device coupled to said processing unit, and including an interface, a computer, and at least one phone member for automatically sending out a warning signal to ask for help when an accident happened,
a speaker for picking up an incoming phone,
a microphone for speaking an out going phone,
at least one handset coupled to said processing unit,
a keypad for data entering purposes, and an anti-theft apparatus coupled to said processing unit.

7. The warning and telecommunicating system according to claim 6, wherein said anti-theft apparatus includes at least one anti-theft device, an air bag actuating device, and a safety button.

8. The warning and telecommunicating system according to claim 6 further comprising a displayer provided in a rear view mirror of the vehicle.
